(19) United States
(12) Patent Application Publication
(10) Pub. No.: US 2026/0343664 A1
(43) Pub. Date: Oct. 29, 2026

(54) SIGNALLING UE CONTEXT AND DATA FROM NG-RAN TO CORE NETWORK

(71) Applicant: TELEFONAKTIEBOLAGET LM ERICSSON (PUBL), Stockholm (SE)

(72) Inventors: Mohammed Yazid Lyazidi, LONDON (GB); Nianshan Shi, JÄRFÄLLA (SE); Qian Chen, MÖLNDAL (SE)

(21) Appl. No.: 19/101,533

(22) PCT Filed: Aug. 8, 2023
(86) PCT No.: PCT/IB2023/058014

§ 371 Date: Feb. 5, 2025

Related U.S. Application Data
(60) Provisional application No. 63/396,132, filed on Aug. 8, 2022.

(51) Int. Cl. H04W 76/27

(52) U.S. Cl. CPC H04W 76/27

(57) ABSTRACT

A wireless system, such as a 5G system, accommodates user equipment (UE) capable of entering an inactive state by signalling a radio access network (RAN)-specific UE context from a RAN node to the core network (CN) when the UE changes to the inactive state. In some embodiments, the RAN node buffers data intended for the UE, and if the context is transferred to the CN while the UE is still inactive, the RAN sends the buffered data to the CN, and the CN takes responsibility for the buffering. If the UE changes to an active state in the area of the RAN node, the CN since the buffered data to the UE through the RAN node. If the UE changes to an active state in the area of a different RAN node, the new RAN node obtains the user context and any buffered data directly from the CN.

### CROSS REFERENCE TO RELATED INFORMATION

This application claims the benefit of U.S.A. priority application No. 63/396,132 filed on Aug. 8, 2022, titled “Methods for signalling UE context and data from NG-RAN to 5GCN.”

### TECHNICAL FIELD

The present disclosure generally relates to the technical field of wireless communications and more particularly to context and data maintenance for devices that are sometimes inactive.

### BACKGROUND

Some user equipment (UE) that connects to wireless networks has an inactive state in which it is not continuously communicating with the network, such as by using DRX (Discontinuous Reception) or eDRX (extended Discontinuous Reception). Some such systems follow Release 18 of TR (technical report) 23.700-68 by 3GPP Working Group SA2, which targets support of UE in an RRC_INACTIVE state with long eDRX (e.g., eDRX>10.24 s), that is, accommodating UE configured to use inactive periods longer than 10.24 s.

In some systems, a next-generation radio access network (“NG-RAN”) provides UE unreachability information (e.g., eDRX information) to the core network (CN) when a UE enters the RRC INACTIVE state with long eDRX, and CN handles the message transfer (MT) data and signalling while the UE is unreachable.

In other systems, the NG-RAN handles MT data/signalling while the UE is in the RRC INACTIVE state. If the UE moves out of the RAN-based notification area (RNA) during the unreachable time period and performs a resume operation outside the RNA, the UE context retrieval between NG-RAN nodes and data forwarding are supported via the CN when there is no Xn interface.

However, there is still a need to establish how an NG-RAN node may provide UE unreachability information to the CN for MT data/signalling handling when the UE is not reachable in the RRC INACTIVE state, or how an NG-RAN node can handle a message (e.g., a new NG Application Protocol (NG-AP) message) to trigger RAN paging when the UE is in the RRC INACTIVE state. Similarly, there is still a need to establish how to perform UE context retrieval to handle data forwarding between NG-RAN nodes via the CN, and also to establish NG-RAN buffering capabilities with respect to MT data for the duration of the eDRX cycle.

In some systems, there is a further need to give NG-RANs the ability to perform a UE context release procedure in coordination with the Access and Mobility Management Function (AMF) of the CN and to locally release the UE to an RRC_IDLE state when receiving a downlink non-access stratum (DL NAS) message and the UE is not reachable for a time period longer than 10.28 s.

In some systems, there is also a need to give NG-RANs the ability to provide an indication to the AMF when the NG RAN receives a DL NAS message and the UE is not reachable for a time period longer than 10.28 s.

### SUMMARY

One embodiment according to the present disclosure comprises a method for supporting a user equipment (UE) that may enter and exit an inactive state.

A further embodiment comprises a network node that supports a UE that may enter and exit an inactive state.

Another embodiment of a method according to the present disclosure is a method performed by a core network for retaining UE context associated with a UE that may enter and exit an inactive state.

Another embodiment can comprise a method performed by a UE for entering and exiting an inactive state.

Another possible embodiment according to the present disclosure is a method performed by a radio access network (RAN) node to support a UE that may enter and exit an inactive state.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 shows a flowchart of a UE entering a CM_CONNECTED state with RRC INACTIVE and eDRX>10.24 s under the present disclosure;

FIG. 2 shows a flowchart of MT signalling for a UE in an RRC_INACTIVE state with long eDRX under the present disclosure;

FIG. 3 shows a flowchart of a procedure for handling UE mobility outside the original RNA under the present disclosure;

FIG. 4 shows a flowchart of by which a UE context is uploaded from an NG-RAN node to the AMF of a core network under the present disclosure;

FIG. 5 shows a flowchart of a method by which an NG-RAN node responds to a UE entering into an RRC_INACTIVE state under the present disclosure;

FIG. 6 shows a flowchart of a method by which a 5GCN node responds to a UE entering into an RRC_INACTIVE state under the present disclosure;

FIG. 7 shows a schematic of a communication system embodiment under the present disclosure;

FIG. 8 shows a schematic of a user equipment embodiment under the present disclosure;

FIG. 9 shows a schematic of a network node embodiment under the present disclosure;

FIG. 10 shows a schematic of a host embodiment under the present disclosure;

FIG. 11 shows a schematic of a virtualization environment embodiment under the present disclosure; and

FIG. 12 shows a schematic representation of an embodiment of communication amongst nodes, hosts, and user equipment under the present disclosure.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

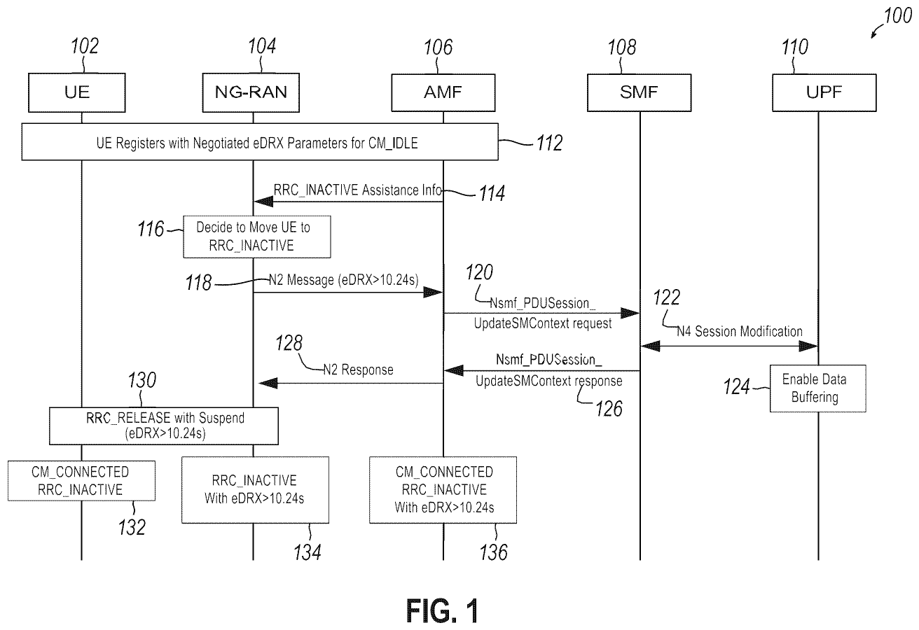

A flowchart for a CN-centric implementation (100) between a UE (102), an NG-RAN (104), and a CN with AMF (106), Session Management Function (SMF) (108), and User Plane Function (UPF) (110) is shown in FIG. 1. First, UE (102) registers (112) with NG-RAN (104) and CN (via AMF (106)) with negotiated eDRX parameters for CM_IDLE. At some point, such as upon NG-RAN (104) receiving (114) a Core Network Assistance Information for RRC INACTIVE information element (IE) in an INITIAL UE CONTEXT SETUP REQUEST message, or any other NG-AP message carrying a request IE for eDRX information, NG-RAN (104) decides (116) to move UE (102) to an RRC_INACTIVE state. NG-RAN (104) sends (118) an N2 message (that is, at reference point N2 in the 5G service-based architecture (SBA), as will be understood by those skilled in the art) to AMF (106) to indicate the move and provide configured eDRX cycle information for the RRC_INACTIVE state. AMF (106) sends (122) SMF (108) an Nsmf_PDUSession UpdateSMContext request, and SMF (108) negotiates (122) a modification of the N4 session with UPF (110). UPF (110) then begins (124) buffering data bound for UE (102). SMF (108) responds (126) to the Nsmf_PDUSession UpdateSMContext request by AMF (106), and AMF (106) sends (128) an N2 response to the NG-RAN (104). NG-RAN (104) then moves (130) UE (102) to an RRC_INACTIVE state in an RRC RELEASE message with SuspendConfig and long eDRX, as will be understood by those skilled in the art. UE (102) is then in CM_CONNECTED and RRC INACTIVE states (132), NG-RAN (104) has UE (102) in the RRC_INACTIVE state with long eDRX (134), and AMF (106) has UE (102) in the CM CONNECTED and RRC INACTIVE states with long eDRX (136).

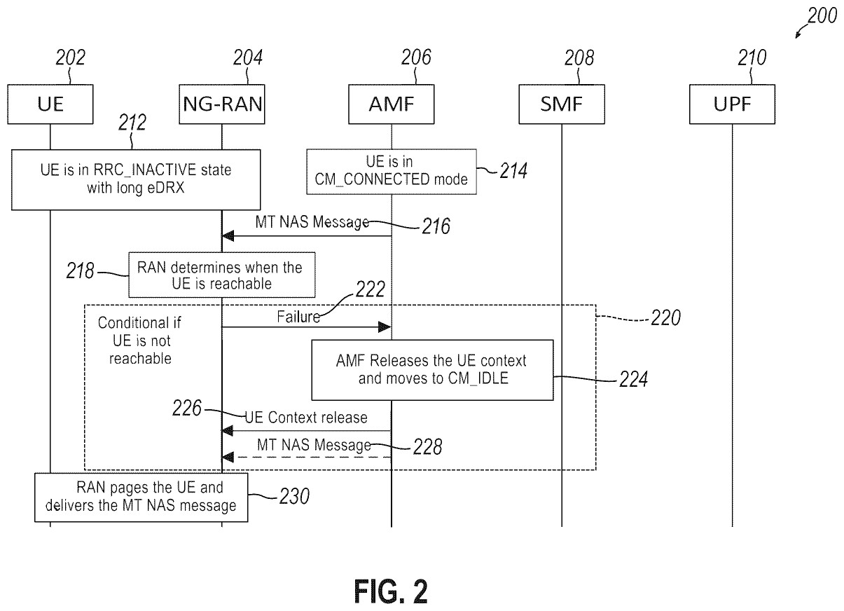

A flowchart for a RAN-centric implementation (200) for dealing with UE in an RRC INACTIVE state with long eDRX is shown in FIG. 2. Similar to the implementation shown in FIG. 1, this implementation (200) includes a UE (202), an NG-RAN (204), and a CN with AMF (206), SMF (208), and UPF (210). In this RAN-centric implementation (200), UE (202) begins in the RRC_INACTIVE state with long eDRX (212), and AMF (206) has the UE (202) in CM_CONNECTED mode (214). When NG-RAN (204) receives an MT NAS message (216) from AMF (206), NG-RAN (204) determines (218) whether UE (202) is reachable and whether the buffering capacity of NG-RAN (204) has been exceeded.

If NG-RAN (204) determines that UE (202) is not reachable or the buffering capacity of NG-RAN (204) has been exceeded, it initiates conditional process (220) by signalling the failure to AMF (206) and moving UE (202) to the RRC_IDLE state via, e.g., a NAS NON DELIVERY INDICATION message (222). AMF (206) releases the UE context and moves it to the CM IDLE state (224). AMF (206) signals the UE context release (226) to the NG-RAN (204). When the NG-RAN (204) receives a subsequent MT NAS message (228) from the AMF (206), NG-RAN (204) pages UE (202) and delivers the MT NAS message (230).

The buffering capability of NG-RAN (204) depends on various factors, such as the deployment scenario (e.g., UPF (210) being collocated with NG-RAN (204), or a split between the control plane and user plane), the traffic model, mobility patterns, or the like. These aspects are generally design features of the applicable deployment or implementation.

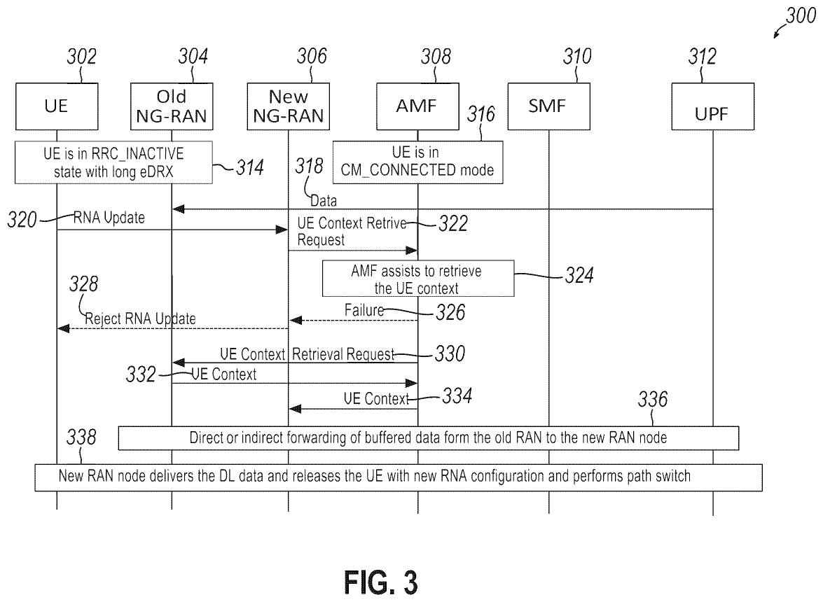

Certain challenges remain. In general, two solutions have been considered: one that is RAN-centric and another that is CN-centric. One impact of the RAN-centric approach is the context fetch done via the CN over the NG-AP when a UE moves to an area where there is no “Xn” connectivity between “gNB” and/or “ng-gNB” base stations, as shown in the implementation (300) illustrated in FIG. 3. In this implementation (300), a UE (302) leaves the RNA of an old NG-RAN (304) and goes into the RNA of a new NG-RAN (306) as facilitated by a core network comprising AMF (308), SMF (310), and UPF (312). At the beginning of the implementation (300), the UE (302) has negotiated an association with old NG-RAN (304) and entered an RRC_INACTIVE state with long eDRX (314). AMF (308) has UE (302) in CM_CONNECTED mode (316).

Data intended for UE (302) arrives through UPF (312) to old NG-RAN (304) and is buffered (318). At some point, UE (302) moves outside the RNA of old NG-RAN (304) and enters the RNA of new NG-RAN (306), sending an RNA update message (320) to new NG-RAN (306). New NG-RAN (306) issues a UE context retrieve request (322) to AMF (308), and AMF (308) assists (324) in the retrieval of the UE context. In the event of a retrieval failure, AMF (308) signals (326) as much to new NG-RAN (306), and new NG-RAN (306) rejects the RNA update (328) by signalling the rejection to UE (302).

If, instead, AMF (308) successfully identifies the old NG-RAN (304) to which the UE (302) was previously connected, AMF (308) issues a UE context retrieval request (330) to old NG-RAN (304) and replies to AMF (308) with the RAN-specific UE context (332). AMF (308) then sends (334) any the RAN-specific UE context to new NG-RAN (306). The data that had been buffered (318) is then forwarded (336) directly or indirectly from old NG-RAN (304) to new NG-RAN (306). After UE (302) comes out of the inactive state, new NG-RAN node (306) delivers the downlink data, releases UE (302) with a new RNA configuration, and performs (338) a path switch as will be understood by those skilled in the art in view of the present disclosure.

The impacts of the RAN-centric solution on the CN cannot be specified without considering the need to enhance the NG-AP interface procedures for optimizing this case, and the full impact of context fetch without Xn, as will sometimes be the case, had not been assessed. Existing solutions have not been enhanced for improving the latency of the mobility procedure, especially when there are several nodes in the 5GCN (e.g., several AMFs) that the signalling and data need to transit between in order to reach the new and old NG-RAN nodes.

Certain aspects of the disclosure and their embodiments may provide solutions to these or other challenges. For example, when the NG-RAN buffering capacity is reached, or the NG-RAN decides that it should switch to CN buffering of the data when moving the UE to RRC_INACTIVE, or based on the particular NG-RAN implementation, the NG-RAN can send a request to the CN to take responsibility for buffering instead, and the NG-RAN can upload a copy of the UE context to CN for storage. This way, both RAN-centric and CN-centric approaches are supported, which can help signalling optimization. Especially, when the UE resumes from RRC INACTIVE in another NG-RAN node without an Xn connection to the previous NG-RAN node, instead of fetching the UE context from the old NG-RAN node via the CN over the NG interface, the 5GCN sends the stored copy of the UE context directly to the new NG-RAN upon receiving the NG-AP context fetch request from the new NG-RAN node. This saves network signalling as steps (330) and (332) from FIG. 3 can be skipped. Further, if the NG-AP context fetch succeeds between the 5CN and new NG-RAN node, the 5GCN can send a request to the old NG-RAN to delete the UE context information stored in the old NG-RAN.

Certain embodiments may provide one or more of the following technical advantages. Some embodiments will reduce network signalling messages and latency when UE context retrieval happens over an NG interface. Other embodiments will facilitate migration from RAN-centric to CN-centric buffering with no foreseen impacts to UEs. Still others will smooth the transition and communication of UE context and data in the network.

Some of the embodiments contemplated herein will now be described more fully with reference to the additional accompanying drawings. Embodiments are provided by way of example to convey the scope of the subject matter to those skilled in the art.

Embodiments under the present disclosure include solutions in the 5GCN and in NG-RAN nodes.

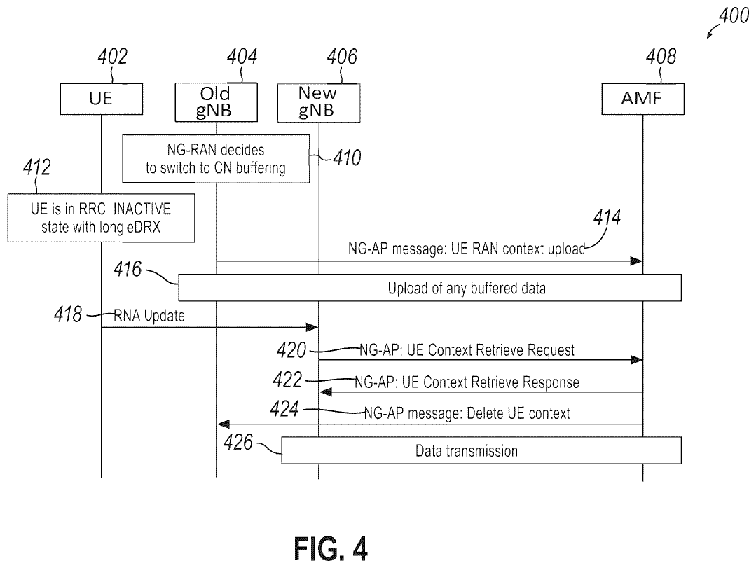

One embodiment of a solution according to the present disclosure is method (400) shown in FIG. 4. Like implementation (300) illustrated in FIG. 3, UE (402) has established a connection with old gNB (404) and moves into the range of new gNB (406) with the support by AMF (408) of a core network. At step (410), the old gNB (404) decides to switch to CN buffering, whether before, after, or simultaneously with the UE (402) being moved to the RRC INACTIVE state (412). At step (414), the old gNB (404) uploads a copy of the RAN-specific UE context to AMF (408), and optionally the old gNB (404) uploads (416) any existing buffered data to the CN. At step (418), the UE (402) performs an RNA update procedure in a new gNB (406) that is not connected via Xn to old gNB (404). New gNB (406) sends (420) a request to AMF (408) for a UE context retrieval over NG-AP. The CN sends (422) the stored UE context to new gNB (406) and decides to resume the connection with UE (402). AMF (408) sends (424) old gNB (404) an NG-AP message instructing it (or giving it permission) to delete the UE context, confirming that the context retrieval via the CN was successfully completed (at step (422)). The CN starts transmitting (426) the buffered data to the new gNB (406).

### NG-RAN Embodiments

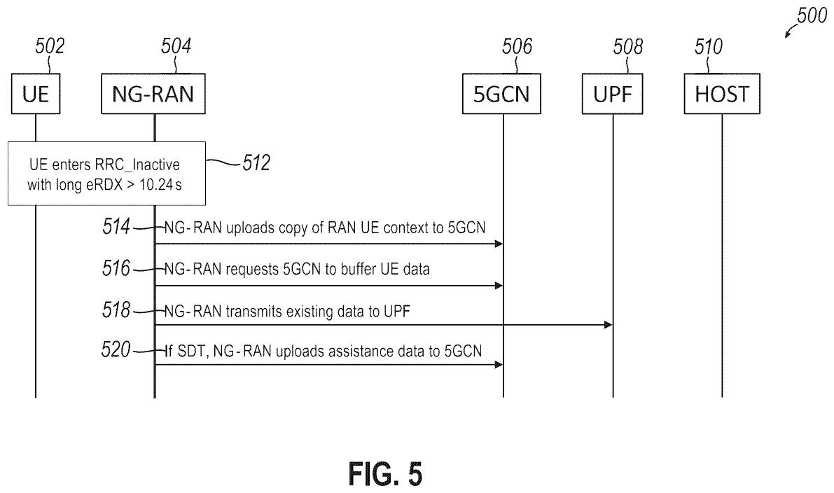

The following illustrates possible steps and aspects in a NG-RAN-oriented embodiment, illustrated as process (500) in FIG. 5. This embodiment includes interactions between a UE (502), an NG-RAN (504), a 5GCN (506), UPF (508), and a host (510). At step (512), UE (502) enters an RRC_INACTIVE state with long eDRX>10.24 s. Alternative triggers may include one or more of: when the UE has been moved to RRC_INACTIVE, or when the buffering capacity of NG-RAN (504) has been reached, or upon request from AMF in 5GCN (506), or when NG-RAN (504) decides to do so based on the network implementation.

At step (514), NG-RAN (504) uploads a copy of the RAN-specific UE context to 5GCN (506) when the UE (502) enters RRC_INACTIVE with long eDRX>10.24 sec. The NG-RAN (504) also requests (516) that 5GCN (506) do (or take over) buffering of the data bound for UE (502) and transmits (518) any existing buffered data to the UPF (508).

In one embodiment, the RAN-specific UE context can contain some or all of the following information:

### UE Context Information

NG-C UE-associated signalling reference
Signalling TNL association address at source
NG-C side
UE Security Capabilities
AS Security Information
Index to RAT/Frequency Selection Priority
UE Aggregate Maximum Bit Rate
PDU Session Resources To Be Setup List
RRC Context
Location Reporting Information
Mobility Restriction List
5GC Mobility Restriction List Container
NR UE Sidelink Aggregate Maximum Bit Rate
LTE UE Sidelink Aggregate Maximum Bit Rate
Management-Based MDT PLMN List
UE Radio Capability ID
MBS Session Information List 5G ProSe UE PC5 Aggregate Maximum Bit Rate
UE Slice Maximum Bit Rate List

If “small data transmission” (SDT) is enabled between UE (502) and 5GCN (506), NG-RAN (504) uploads (520) assistance data for SDT (e.g., a SDT Support Request IE, as will be understood by those skilled in the art) to 5GCN (506) to assist the RAN-specific UE context retrieval procedure.

In some embodiments, the message used to signal the copy of the RAN-specific UE context is a NG-AP message, which can either be initiated by NG-RAN (504) or requested by 5GCN (506).

### 5GCN EMBODIMENTS

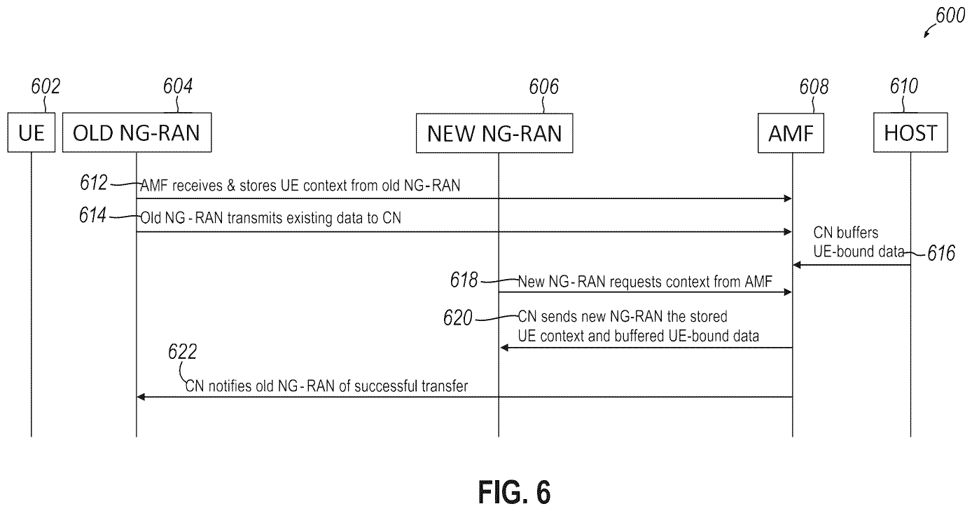

The following illustrates possible steps and aspects in a 5GCN-oriented embodiment, illustrated as process (600) in FIG. 6. This embodiment includes interactions between a UE (602), an old NG-RAN (604), a new NG-RAN (606), 5GCN AMF (608), and a host (610). At step (612), AMF (608) receives a copy of the RAN-specific UE context for UE (602), which is in the RRC INACTIVE state, from old NG-RAN (604), and AMF (608) stores that UE context. Old NG-RAN (604) transmits (614) to AMF (608) any data bound for UE (602) that it has buffered, and the 5GCN (e.g., AMF (608)) begins buffering (616) data from host (610) bound for UE (602).

Upon receiving a request at step (618) for a context fetch from new NG-RAN node (606) to the AMF (608) via a NG-AP context retrieve message, AMF (608) of the 5GCN can send (620) the stored copy of the RAN-specific UE context directly to new NG-RAN (606) without exchanging messages with old NG-RAN (604), as the information is already available to the 5GCN. In some embodiments, if buffered data was sent to the CN from old NG-RAN (604) at step (614), AMF (608) can also send that and any subsequently received and buffered data to new NG-RAN (606) at step (620). If data is also uploaded from old NG-RAN (604) at step (614), or if implementation (600) is so designed, the CN starts buffering the received data as step (616).

If SDT with anchor relocation is enabled for UE (602), the AMF (608) signals the full RAN-specific UE context to the new NG-RAN node (606). If, on the other hand, SDT without anchor relocation is enabled for UE (602), AMF (608) transfers an applicable part of the RAN-specific UE context to new NG-RAN node (606).

After a successful context retrieval procedure between new NG-RAN node (606) and the CN, AMF (608) sends a NG-AP message to old NG-RAN (604) to notify it of the success and inform old NG-RAN (604) that it can delete the UE context information for UE (602) that was previously uploaded.

In one embodiment, the AMF (608) can also indicate to old NG-RAN node (604) the cell ID of the new cell in new NG-RAN node (606) where the UE (602) has resumed.

### ADDITIONAL EMBODIMENTS

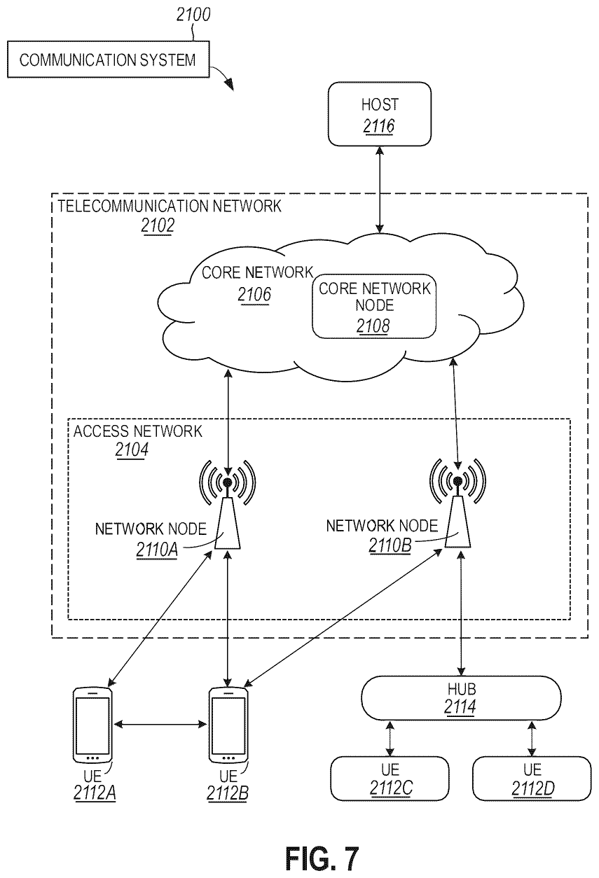

FIG. 7 shows an example of a communication system 2100 in accordance with some embodiments.

In the example, the communication system 2100 includes a telecommunication network 2102 that includes an access network 2104, such as a radio access network (RAN), and a core network 2106, which includes one or more core network nodes 2108. The access network 2104 includes one or more access network nodes, such as network nodes 2110a and 2110b (one or more of which may be generally referred to as network nodes 2110), or any other similar 3rd Generation Partnership Project (3GPP) access node or non-3GPP access point. The network nodes 2110 facilitate direct or indirect connection of user equipment (UE), such as by connecting UEs 2112a, 2112b, 2112c, and 2112d (one or more of which may be generally referred to as UEs 2112) to the core network 2106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2100 may include any number of wired or wireless networks, network nodes, UEs, and/or any other components or systems that may facilitate or participate in the communication of data and/or signals whether via wired or wireless connections. The communication system 2100 may include and/or interface with any type of communication, telecommunication, data, cellular, radio network, and/or other similar type of system.

The UEs 2112 may be any of a wide variety of communication devices, including wireless devices arranged, configured, and/or operable to communicate wirelessly with the network nodes 2110 and other communication devices. Similarly, the network nodes 2110 are arranged, capable, configured, and/or operable to communicate directly or indirectly with the UEs 2112 and/or with other network nodes or equipment in the telecommunication network 2102 to enable and/or provide network access, such as wireless network access, and/or to perform other functions, such as administration in the telecommunication network 2102.

In the depicted example, the core network 2106 connects the network nodes 2110 to one or more hosts, such as host 2116. These connections may be direct or indirect via one or more intermediary networks or devices. In other examples, network nodes may be directly coupled to hosts. The core network 2106 includes one or more core network nodes (e.g., core network node 2108) that are structured with hardware and software components. Features of these components may be substantially similar to those described with respect to the UEs, network nodes, and/or hosts, such that the descriptions thereof are generally applicable to the corresponding components of the core network node 2108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2116 may be under the ownership or control of a service provider other than an operator or provider of the access network 2104 and/or the telecommunication network 2102, and host 2116 may be operated by the service provider or on behalf of the service provider. The host 2116 may host a variety of applications to provide one or more services. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2100 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, and our 5G standards, or any applicable future generation standard (e.g., 6G); wireless local area network (WLAN) standards, such as the Institute of Electrical and Electronics Engineers (IEEE) 802.11 standards (Wi-Fi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2102 is a cellular network that implements 3GPP standardized features. Accordingly, the telecommunications network 2102 may support network slicing to provide different logical networks to different devices that are connected to the telecommunication network 2102. For example, the telecommunications network 2102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2112 are configured to transmit and/or receive information without direct human interaction. For instance, a UE may be designed to transmit information to the access network 2104 on a predetermined schedule, when triggered by an internal or external event, or in response to requests from the access network 2104. Additionally, a UE may be configured for operating in single-or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 2114 communicates with the access network 2104 to facilitate indirect communication between one or more UEs (e.g., UE 2112c and/or 2112d) and network nodes (e.g., network node 2110b). In some examples, the hub 2114 may be a controller, router, content source and analytics, or any of the other communication devices described herein regarding UEs. For example, the hub 2114 may be a broadband router enabling access to the core network 2106 for the UEs. As another example, the hub 2114 may be a controller that sends commands or instructions to one or more actuators in the UEs. Commands or instructions may be received from the UEs, network nodes 2110, or by executable code, script, process, or other instructions in the hub 2114. As another example, the hub 2114 may be a data collector that acts as temporary storage for UE data and, in some embodiments, may perform analysis or other processing of the data. As another example, the hub 2114 may be a content source. For example, for a UE that is a VR headset, display, loudspeaker or other media delivery device, the hub 2114 may retrieve VR assets, video, audio, or other media or data related to sensory information via a network node, which the hub 2114 then provides to the UE either directly, after performing local processing, and/or after adding additional local content. In still another example, the hub 2114 acts as a proxy server or orchestrator for the UEs, in particular in if one or more of the UEs are low energy IoT devices.

The hub 2114 may have a constant/persistent or intermittent connection to the network node 2110b. The hub 2114 may also allow for a different communication scheme and/or schedule between the hub 2114 and UEs (e.g., UE 2112c and/or 2112d), and between the hub 2114 and the core network 2106. In other examples, the hub 2114 is connected to the core network 2106 and/or one or more UEs via a wired connection. Moreover, the hub 2114 may be configured to connect to an M2M service provider over the access network 2104 and/or to another UE over a direct connection. In some scenarios, UEs may establish a wireless connection with the network nodes 2110 while still connected via the hub 2114 via a wired or wireless connection. In some embodiments, the hub 2114 may be a dedicated hub-that is, a hub whose primary function is to route communications to/from the UEs from/to the network node 2110b. In other embodiments, the hub 2114 may be a non-dedicated hub-that is, a device which is capable of operating to route communications between the UEs and network node 2110b, but which is additionally capable of operating as a communication start and/or end point for certain data channels.

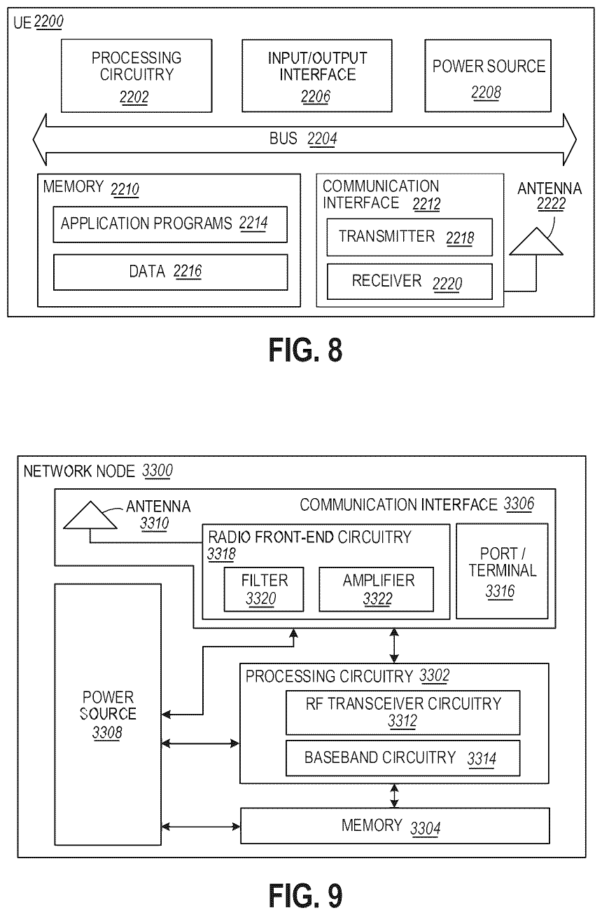

FIG. 8 shows a UE 2200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2200 includes processing circuitry 2202 that is operatively coupled via a bus 2204 to an input/output interface 2206, a power source 2208, a memory 2210, a communication interface 2212, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 2202 is configured to process instructions and data and may be configured to implement any sequential state machine operative to execute instructions stored as machine-readable computer programs in the memory 2210. The processing circuitry 2202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2202 may include multiple central processing units (CPUs).

In the example, the input/output interface 2206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2208 is structured as a battery or battery pack. Other types of power sources, such as an external power source (e.g., an electricity outlet), photovoltaic device, or power cell, may be used. The power source 2208 may further include power circuitry for delivering power from the power source 2208 itself, and/or an external power source, to the various parts of the UE 2200 via input circuitry or an interface such as an electrical power cable. Delivering power may be, for example, for charging of the power source 2208.

Power circuitry may perform any formatting, converting, or other modification to the power from the power source 2208 to make the power suitable for the respective components of the UE 2200 to which power is supplied.

The memory 2210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2210 includes one or more application programs 2214, such as an operating system, web browser application, a widget, gadget engine, or other application, and corresponding data 2216. The memory 2210 may store, for use by the UE 2200, any of a variety of various operating systems or combinations of operating systems.

The memory 2210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as a “SIM card.” The memory 2210 may allow the UE 2200 to access instructions, application programs and the like, stored on transitory or non-transitory memory media, to off-load data, or to upload data. An article of manufacture, such as one utilizing a communication system may be tangibly embodied as or in the memory 2210, which may be or comprise a device-readable storage medium.

The processing circuitry 2202 may be configured to communicate with an access network or other network using the communication interface 2212. The communication interface 2212 may comprise one or more communication subsystems and may include or be communicatively coupled to an antenna 2222. The communication interface 2212 may include one or more transceivers used to communicate, such as by communicating with one or more remote transceivers of another device capable of wireless communication (e.g., another UE or a network node in an access network). Each transceiver may include a transmitter 2218 and/or a receiver 2220 appropriate to provide network communications (e.g., optical, electrical, frequency allocations, and so forth). Moreover, the transmitter 2218 and receiver 2220 may be coupled to one or more antennas (e.g., antenna 2222) and may share circuit components, software or firmware, or alternatively be implemented separately.

In the illustrated embodiment, communication functions of the communication interface 2212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2200 shown in FIG. 8.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 2300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2300 includes a processing circuitry 2302, a memory 2304, a communication interface 2306, and a power source 2308. The network node 2300 may be composed of multiple physically separate components (e.g., a NodeB component and a RNC component, or a BTS component and a BSC component, etc.), which may each have their own respective components. In certain scenarios in which the network node 2300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2300 may be configured to support multiple radio access technologies (RATs). In such embodiments, some components may be duplicated (e.g., separate memory 2304 for different RATs) and some components may be reused (e.g., a same antenna 2310 may be shared by different RATs). The network node 2300 may also include multiple sets of the various illustrated components for different wireless technologies integrated into network node 2300, for example GSM, WCDMA, LTE, NR, Wi-Fi, Zigbee, Z-wave, LoRaWAN, Radio Frequency Identification (RFID) or Bluetooth wireless technologies. These wireless technologies may be integrated into the same or different chip or set of chips and other components within network node 2300.

The processing circuitry 2302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2300 components, such as the memory 2304, to provide network node 2300 functionality.

In some embodiments, the processing circuitry 2302 includes a system on a chip (SOC). In some embodiments, the processing circuitry 2302 includes one or more of radio frequency (RF) transceiver circuitry 2312 and baseband processing circuitry 2314. In some embodiments, the radio frequency (RF) transceiver circuitry 2312 and the baseband processing circuitry 2314 may be on separate chips (or sets of chips), boards, or units, such as radio units and digital units. In alternative embodiments, part or all of RF transceiver circuitry 2312 and baseband processing circuitry 2314 may be on the same chip or set of chips, boards, or units.

The memory 2304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2302. The memory 2304 may store any suitable instructions, data, or information, including a computer program, software, an application including one or more of logic, rules, code, tables, and/or other instructions capable of being executed by the processing circuitry 2302 and utilized by the network node 2300. The memory 2304 may be used to store any calculations made by the processing circuitry 2302 and/or any data received via the communication interface 2306. In some embodiments, the processing circuitry 2302 and memory 2304 are integrated.

The communication interface 2306 is used in wired or wireless communication of signalling and/or data between a network node, access network, and/or UE. As illustrated, the communication interface 2306 comprises port(s)/terminal(s) 2316 to send and receive data, for example to and from a network over a wired connection. The communication interface 2306 also includes radio front-end circuitry 2318 that may be coupled to, or in certain embodiments a part of, the antenna 2310. Radio front-end circuitry 2318 comprises filters 2320 and amplifiers 2322. The radio front-end circuitry 2318 may be connected to an antenna 2310 and processing circuitry 2302. The radio front-end circuitry may be configured to condition signals communicated between antenna 2310 and processing circuitry 2302. The radio front-end circuitry 2318 may receive digital data that is to be sent out to other network nodes or UEs via a wireless connection. The radio front-end circuitry 2318 may convert the digital data into a radio signal having the appropriate channel and bandwidth parameters using a combination of filters 2320 and/or amplifiers 2322. The radio signal may then be transmitted via the antenna 2310. Similarly, when receiving data, the antenna 2310 may collect radio signals which are then converted into digital data by the radio front-end circuitry 2318. The digital data may be passed to the processing circuitry 2302. In other embodiments, the communication interface may comprise different components and/or different combinations of components.

In certain alternative embodiments, the network node 2300 does not include separate radio front-end circuitry 2318, instead, the processing circuitry 2302 includes radio front-end circuitry and is connected to the antenna 2310. Similarly, in some embodiments, all or some of the RF transceiver circuitry 2312 is part of the communication interface 2306. In still other embodiments, the communication interface 2306 includes one or more ports or terminals 2316, the radio front-end circuitry 2318, and the RF transceiver circuitry 2312, as part of a radio unit (not shown), and the communication interface 2306 communicates with the baseband processing circuitry 2314, which is part of a digital unit (not shown).

The antenna 2310 may include one or more antennas, or antenna arrays, configured to send and/or receive wireless signals. The antenna 2310 may be coupled to the radio front-end circuitry 2318 and may be any type of antenna capable of transmitting and receiving data and/or signals wirelessly. In certain embodiments, the antenna 2310 is separate from the network node 2300 and connectable to the network node 2300 through an interface or port.

The antenna 2310, communication interface 2306, and/or the processing circuitry 2302 may be configured to perform any receiving operations and/or certain obtaining operations described herein as being performed by the network node. Any information, data and/or signals may be received from a UE, another network node and/or any other network equipment. Similarly, the antenna 2310, the communication interface 2306, and/or the processing circuitry 2302 may be configured to perform any transmitting operations described herein as being performed by the network node. Any information, data and/or signals may be transmitted to a UE, another network node and/or any other network equipment.

The power source 2308 provides power to the various components of network node 2300 in a form suitable for the respective components (e.g., at a voltage and current level needed for each respective component). The power source 2308 may further comprise, or be coupled to, power management circuitry to supply the components of the network node 2300 with power for performing the functionality described herein. For example, the network node 2300 may be connectable to an external power source (e.g., the power grid, an electricity outlet) via an input circuitry or interface such as an electrical cable, whereby the external power source supplies power to power circuitry of the power source 2308. As a further example, the power source 2308 may comprise a source of power in the form of a battery or battery pack which is connected to, or integrated in, power circuitry. The battery may provide backup power should the external power source fail.

Embodiments of the network node 2300 may include additional components beyond those shown in FIG. 9 for providing certain aspects of the network node's functionality, including any of the functionality described herein and/or any functionality necessary to support the subject matter described herein. For example, the network node 2300 may include user interface equipment to allow input of information into the network node 2300 and to allow output of information from the network node 2300. This may allow a user to perform diagnostic, maintenance, repair, and other administrative functions for the network node 2300.

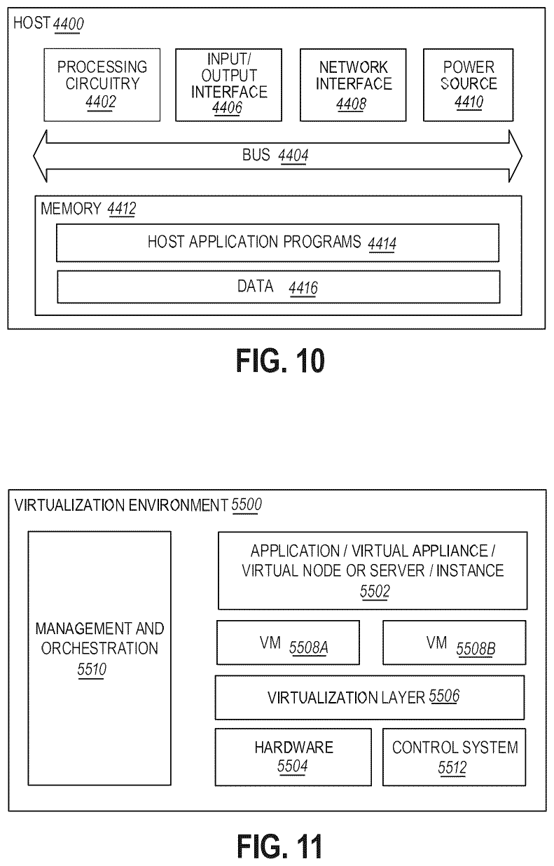

FIG. 10 is a block diagram of a host 2400, which may be an embodiment of the host 2116 of FIG. 7, in accordance with various aspects described herein. As used herein, the host 2400 may be or comprise various combinations hardware and/or software, including a standalone server, a blade server, a cloud-implemented server, a distributed server, a virtual machine, container, or processing resources in a server farm. The host 2400 may provide one or more services to one or more UEs.

The host 2400 includes processing circuitry 2402 that is operatively coupled via a bus 2404 to an input/output interface 2406, a network interface 2408, a power source 2410, and a memory 2412. Other components may be included in other embodiments. Features of these components may be substantially similar to those described with respect to the devices of previous figures, such as FIGS. 22 and 23, such that the descriptions thereof are generally applicable to the corresponding components of host 2400.

The memory 2412 may include one or more computer programs including one or more host application programs 2414 and data 2416, which may include user data, e.g., data generated by a UE for the host 2400 or data generated by the host 2400 for a UE. Embodiments of the host 2400 may utilize only a subset or all of the components shown. The host application programs 2414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2414 may also provide for user authentication and licensing checks and may periodically report health, routes, and content availability to a central node, such as a device in or on the edge of a core network. Accordingly, the host 2400 may select and/or indicate a different host for over-the-top services for a UE. The host application programs 2414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment 2500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2506 (also referred to as hypervisors or virtual machine monitors (VMMs)), provide VMs 2508a and 2508b (one or more of which may be generally referred to as VMs 2508), and/or perform any of the functions, features and/or benefits described in relation with some embodiments described herein. The virtualization layer 2506 may present a virtual operating platform that appears like networking hardware to the VMs 2508.

The VMs 2508 comprise virtual processing, virtual memory, virtual networking or interface and virtual storage, and may be run by a corresponding virtualization layer 2506. Different embodiments of the instance of a virtual appliance 2502 may be implemented on one or more of VMs 2508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2508 may be a software implementation of a physical machine that runs programs as if they were executing on a physical, non-virtualized machine. Each of the VMs 2508, and that part of hardware 2504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2508 on top of the hardware 2504 and corresponds to the application 2502.

Hardware 2504 may be implemented in a standalone network node with generic or specific components. Hardware 2504 may implement some functions via virtualization.

Alternatively, hardware 2504 may be part of a larger cluster of hardware (e.g., such as in a data center or CPE) where many hardware nodes work together and are managed via management and orchestration 2510, which, among others, oversees lifecycle management of applications 2502. In some embodiments, hardware 2504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system 2512 which may alternatively be used for communication between hardware nodes and radio units.

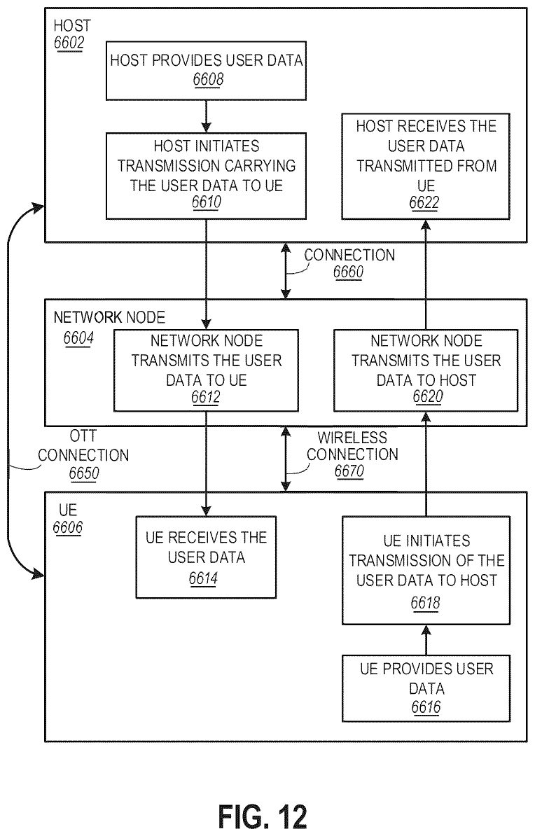

FIG. 12 shows a communication diagram of a host 2602 communicating via a network node 2604 with a UE 2606 over a partially wireless connection in accordance with some embodiments. Example implementations, in accordance with various embodiments, of the UE (such as a UE 2112a of FIG. 7 and/or UE 2200 of FIG. 8), network node (such as network node 2110a of FIG. 7 and/or network node 2300 of FIG. 9), and host (such as host 2116 of FIG. 7 and/or host 2400 of FIG. 10) discussed in the preceding paragraphs will now be described with reference to FIG. 12.

Like host 2400, embodiments of host 2602 include hardware, such as a communication interface, processing circuitry, and memory. The host 2602 also includes software, which is stored in or accessible by the host 2602 and executable by the processing circuitry. The software includes a host application that may be operable to provide a service to a remote user, such as the UE 2606 connecting via an over-the-top (OTT) connection 2650 extending between the UE 2606 and host 2602. In providing the service to the remote user, a host application may provide user data which is transmitted using the OTT connection 2650.

The network node 2604 includes hardware enabling it to communicate with the host 2602 and UE 2606. The connection 2660 may be direct or pass through a core network (like core network 2106 of FIG. 7) and/or one or more other intermediate networks, such as one or more public, private, or hosted networks. For example, an intermediate network may be a backbone network or the Internet.

The UE 2606 includes hardware and software, which is stored in or accessible by UE 2606 and executable by the UE's processing circuitry. The software includes a client application, such as a web browser or operator-specific “app” that may be operable to provide a service to a human or non-human user via UE 2606 with the support of the host 2602. In the host 2602, an executing host application may communicate with the executing client application via the OTT connection 2650 terminating at the UE 2606 and host 2602. In providing the service to the user, the UE's client application may receive request data from the host's host application and provide user data in response to the request data. The OTT connection 2650 may transfer both the request data and the user data. The UE's client application may interact with the user to generate the user data that it provides to the host application through the OTT connection 2650.

The OTT connection 2650 may extend via a connection 2660 between the host 2602 and the network node 2604 and via a wireless connection 2670 between the network node 2604 and the UE 2606 to provide the connection between the host 2602 and the UE 2606. The connection 2660 and wireless connection 2670, over which the OTT connection 2650 may be provided, have been drawn abstractly to illustrate the communication between the host 2602 and the UE 2606 via the network node 2604, without explicit reference to any intermediary devices and the precise routing of messages via these devices.

As an example of transmitting data via the OTT connection 2650, in step 2608, the host 2602 provides user data, which may be performed by executing a host application. In some embodiments, the user data is associated with a particular human user interacting with the UE 2606. In other embodiments, the user data is associated with a UE 2606 that shares data with the host 2602 without explicit human interaction. In step 2610, the host 2602 initiates a transmission carrying the user data towards the UE 2606. The host 2602 may initiate the transmission responsive to a request transmitted by the UE 2606. The request may be caused by human interaction with the UE 2606 or by operation of the client application executing on the UE 2606. The transmission may pass via the network node 2604, in accordance with the teachings of the embodiments described throughout this disclosure. Accordingly, in step 2612, the network node 2604 transmits to the UE 2606 the user data that was carried in the transmission that the host 2602 initiated, in accordance with the teachings of the embodiments described throughout this disclosure. In step 2614, the UE 2606 receives the user data carried in the transmission, which may be performed by a client application executed on the UE 2606 associated with the host application executed by the host 2602.

In some examples, the UE 2606 executes a client application which provides user data to the host 2602. The user data may be provided in reaction or response to the data received from the host 2602. Accordingly, in step 2616, the UE 2606 may provide user data, which may be performed by executing the client application. In providing the user data, the client application may further consider user input received from the user via an input/output interface of the UE 2606. Regardless of the specific manner in which the user data was provided, the UE 2606 initiates, in step 2618, transmission of the user data towards the host 2602 via the network node 2604. In step 2620, in accordance with the teachings of the embodiments described throughout this disclosure, the network node 2604 receives user data from the UE 2606 and initiates transmission of the received user data towards the host 2602. In step 2622, the host 2602 receives the user data carried in the transmission initiated by the UE 2606.

One or more of the various embodiments improve the performance of OTT services provided to the UE 2606 using the OTT connection 2650, in which the wireless connection 2670 forms the last segment. More precisely, the teachings of these embodiments may improve the data rate, latency, power consumption or other factors and thereby provide benefits such as reduced user waiting time, relaxed restriction on file size, improved content resolution, better responsiveness, extended battery lifetime.

In an example scenario, factory status information may be collected and analyzed by the host 2602. As another example, the host 2602 may process audio and video data which may have been retrieved from a UE for use in creating maps. As another example, the host 2602 may collect and analyze real-time data to assist in controlling vehicle congestion (e.g., controlling traffic lights). As another example, the host 2602 may store surveillance video uploaded by a UE. As another example, the host 2602 may store or control access to media content such as video, audio, VR or AR which it can broadcast, multicast or unicast to UEs. As other examples, the host 2602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2650 between the host 2602 and UE 2606, in response to variations in the measurement results. The measurement procedure and/or the network functionality for reconfiguring the OTT connection may be implemented in software and hardware of the host 2602 and/or UE 2606. In some embodiments, sensors (not shown) may be deployed in or in association with other devices through which the OTT connection 2650 passes; the sensors may participate in the measurement procedure by supplying values of the monitored quantities exemplified above, or supplying values of other physical quantities from which software may compute or estimate the monitored quantities. The reconfiguring of the OTT connection 2650 may include message format, retransmission settings, preferred routing etc.; the reconfiguring need not directly alter the operation of the network node 2604. Such procedures and functionalities may be known and practiced in the art. In certain embodiments, measurements may involve proprietary UE signalling that facilitates measurements of throughput, propagation times, latency and the like, by the host 2602. The measurements may be implemented in that software causes messages to be transmitted, in particular empty or ‘dummy’ messages, using the OTT connection 2650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

1. A method performed by a core network (CN) for supporting a user equipment that is inactive, where the CN comprises a network node, the method comprising:
receiving, by the network node, a copy of a radio access network (RAN)-specific user equipment (UE) context for a UE in an inactive state from a first wireless access node;
storing, by the network node, the UE context for the UE; and
providing the UE context to a second wireless access node.

2. The method of claim 1, further comprising buffering data for the UE while the UE is in the inactive state.

3. The method of claim 2, further comprising sending the buffered data to the second wireless access node.

4. The method claim 1, wherein providing the RAN-specific UE context comprises sending the stored RAN-specific UE context directly to the second wireless access node without exchanging messages with the first wireless access node.

5. The method of claim 1, wherein a request for context fetch arrives via a NG-AP context retrieve message and triggers the providing step.

6. The method of claim 1, wherein the UE implements a Small Data Transmission (SDT) protocol with anchor relocation, and providing the RAN-specific UE context comprises providing the full RAN-specific UE context to the second wireless access node.

7. The method of claim 1, wherein the UE implements a Small Data Transmission (SDT) protocol without anchor relocation, and providing the RAN-specific UE context comprises providing part of the RAN-specific UE context to the second wireless access node.

8. The method of claim 1, further comprising providing a cell ID of a new cell associated with the second wireless access node.

9. The method of claim 1, wherein the second wireless access node has no Xn connection with the network node.

10. The method of claim 1, further comprising:
providing user data; and
forwarding the user data to a host via the transmission to the network node.

11-34. (canceled)

35. A network node within a core network (CN), the network node configured to support a user equipment that is inactive, wherein the network node comprises:
radio circuitry configured to receive a copy of a radio access network (RAN)-specific user equipment (UE) context for a UE in an inactive state from a first wireless access node; and
memory configured to electronically store the UE context for the UE;
wherein the radio circuitry is further configured to provide the RAN specific UE context to a second wireless access node.

36. The network node of claim 35, wherein the memory is further configured to buffer data for the UE while the UE is in the inactive state.

37. The network node of claim 36, wherein the radio circuitry is further configured to send the buffered data to the second wireless access node.

38. The network node of claims 35, wherein the radio circuitry configured to provide the RAN-specific UE context is further configured to send the stored RAN-specific UE context directly to the second wireless access node without exchanging messages with the first wireless access node.

39. The network node of claims 35, wherein the radio circuitry is further configured to receive a NG-AP context retrieve message comprising a request for context fetch, wherein the UE context is provided to the second wireless access node based on the NG-AP context retrieve message comprising the request for context fetch.

40. The network node of claims 35, wherein the radio circuitry is configured to provide the full RAN-specific UE context to the second wireless access node based on the UE implementing a Small Data Transmission (SDT) protocol with anchor relocation.

41. The network node of claims 35, wherein the radio circuitry is configured to provide part of the full RAN-specific UE context to the second wireless access node based on the UE implementing a Small Data Transmission (SDT) protocol without anchor relocation.

42. The network node of claims 35, wherein the radio circuitry is further configured to provide a cell ID of a new cell associated with the second wireless access node.

43. The network node of claims 35, wherein the second wireless access node has no Xn connection with the network node.

44. The network node of claims 35, wherein the radio circuitry is further configured to:
provide user data; and
forward the user data to a host via transmission to the network node.
